(19) United States
(12) Patent Application Publication
(10) Pub. No.: US 2006/0006598 A1
(43) Pub. Date: Jan. 12, 2006

(54) Seal mechanism in compressor

(76) Inventors: Kazuya Kimura, (US); Masao Iguchi, (US); Izuru Shimizu, (US); Yumin Hishinuma, (US)

Correspondence Address: KNOBLE YOSHIDA & DUNLEAVY LLC;Eight Penn Center, Suite 1350, 1628 John F. Kennedy Blvd., Philadelphia, PA, 19103, US

(21) Appl. No.: 11/153,833

(22) Filed: Jun. 15, 2005

(30) Foreign Application Priority Data
Jun. 21, 2004 (JP) 2004-182094

(51) Int. Cl. F16J 15/43

(52) U.S. Cl. 277/302

(57) ABSTRACT

A compressor includes a housing having a high-pressure region and a low-pressure region, a rotary shaft, a compression unit, and a seal member. The seal member has an annular and plate-like shape and is provided in the housing for preventing gas from leaking from the high-pressure region to the low-pressure region via a gap between the rotary shaft and the housing. Pressure of the gas in the high-pressure region is applied to the seal member thereby generating a seal function. The seal member is fixed to one of the housing and the rotary shaft and in contact with an edge that is formed in the other of the housing and the rotary shaft and connects a first-surface facing the high-pressure region and a circumferential surface coaxial with the rotary shaft in the other of the housing and the rotary shaft.

### BACKGROUND OF THE INVENTION

The present invention relates to a seal mechanism for sealing a gap between a rotary shaft and a housing in a compressor, for example, of a scroll type, a piston type and a vane type.

A scroll compressor used as a refrigerant compressor includes a housing, a fixed scroll member and a movable scroll member. A back pressure chamber is defined behind the fixed scroll member for enhancing the sealing between the fixed and movable scroll members. The back pressure chamber is the space which is formed between a fixed wall provided in the housing and the movable scroll member The pressure in the back pressure chamber (or back pressure) is increased and applied to the movable scroll member. A gas compressed to a high pressure by a compression unit is introduced into the back pressure chamber. In the back pressure chamber is disposed an orbital mechanism that converts the rotation of a rotary shaft into the orbital movement of the movable scroll member. A known lip seal or tip seal is provided between the fixed wall and the rotary shaft to seal the back pressure chamber for preventing the introduced high-pressure gas in the back pressure chamber from leaking to a low-pressure region behind the fixed wall.

Meanwhile, besides the lip seal and the tip seal, there have been known other seal mechanisms such as a labyrinth seal and a seal mechanism for a rotary valve as disclosed in Unexamined Japanese Patent Publication No. 11-63244.

Recently, chlorofluorocarbon-based refrigerant used as refrigerant for the refrigerant compressor has been replaced by carbon dioxide. When carbon dioxide is used as the refrigerant, the pressure of the refrigerant becomes extremely high in operation of the compressor in comparison with the case of using chlorofluorocarbon-based refrigerant. The same is true of the scroll compressor. Therefore, in the scroll compressor, the pressure in the back pressure chamber is also much higher when using carbon dioxide in place of chlorofluorocarbon-based refrigerant.

When a conventional contact type seal member such as the lip seal and the tip seal is provided between the fixed wall and the rotary shaft, the seal member is pressed strongly against the rotary shaft because of the extremely large pressure difference between the back pressure chamber and the low-pressure region behind the fixed wall. Thus, the sealing may be enhanced, but sliding resistance between the seal member and the rotary shaft is extremely large when the seal member slides relative to the rotary shaft. Accordingly, the torque of the rotary shaft is increased, thereby inviting a wear of the seal member. Meanwhile, when another seal mechanism such as the non-contact type labyrinth seal is used as an alternative of the lip seal and the tip seal, the sliding resistance between the seal member and the rotary shaft is small. However, such seal mechanism does not function properly when the above pressure difference is large. Thus, the high-pressure gas in the back pressure chamber easily leaks into the low-pressure region. Though the leaking itself is not a serious problem, if the high-pressure gas leaks too much, the back pressure chamber does not perform its intended function, so that satisfactory sealing between the fixed and movable scroll members is not ensured.

A seal mechanism for a rotary valve is disclosed in Unexamined Japanese Patent Publication No. 11-63244. However, it is designed primarily for sealing and its sliding resistance is large as the aforementioned lip seal and tip seal. In addition, the seal mechanism formed with a protrusion and having a coil spring is complicated in structure. Therefore, such seal mechanism is not suitable for use in the compressor.

The present invention is directed to a compressor having a seal mechanism that ensures the sealing and is simple in structure, as well as reduces the sliding resistance between a seal member and a sliding surface.

### SUMMARY OF THE INVENTION

According to the present invention, a compressor for compressing gas includes a housing, a rotary shaft, a compression unit, and a seal member. The housing has a high-pressure region and a low-pressure region. The rotary shaft is rotatably supported by the housing. The compression unit is provided in the housing and is actuated by the rotation of the rotary shaft to perform the gas compression. The seal member has an annular and plate-like shape and is provided in the housing for preventing the gas from leaking from the high-pressure region to the low-pressure region via a gap between the rotary shaft and the housing. Pressure of the gas in the high-pressure region is applied to the seal member thereby generating a seal function. The seal member is fixed to one of the housing and the rotary shaft and in contact with an edge that is formed in the other of the housing and the rotary shaft and connects a first surface facing the high-pressure region and a circumferential surface coaxial with the rotary shaft in the other of the housing and the rotary shaft.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a longitudinal cross-sectional view of a motor-driven scroll compressor of a first preferred embodiment according to the present invention;

FIG. 2 is an enlarged partial cross-sectional view showing part of the compressor which is enclosed by the dotted oval line A in FIG. 1;

FIG. 3 is a partially enlarged cross-sectional view of a compressor showing a seal mechanism of an alternative embodiment;

FIG. 4 is a partially enlarged cross-sectional view of a compressor showing a seal mechanism of an alternative embodiment; and

FIG. 5 is a partially enlarged cross-sectional view of a compressor showing a seal mechanism of an alternative embodiment.

### DETAILED DESCRIPTION OF THE PREFERRED EMBODIMENTS

The following will describe a first preferred embodiment, in which the present invention is applied to a motor-driven scroll compressor for use in the refrigerant circuit of a vehicle air-conditioner and using carbon dioxide as the refrigerant of the refrigerating circuit.

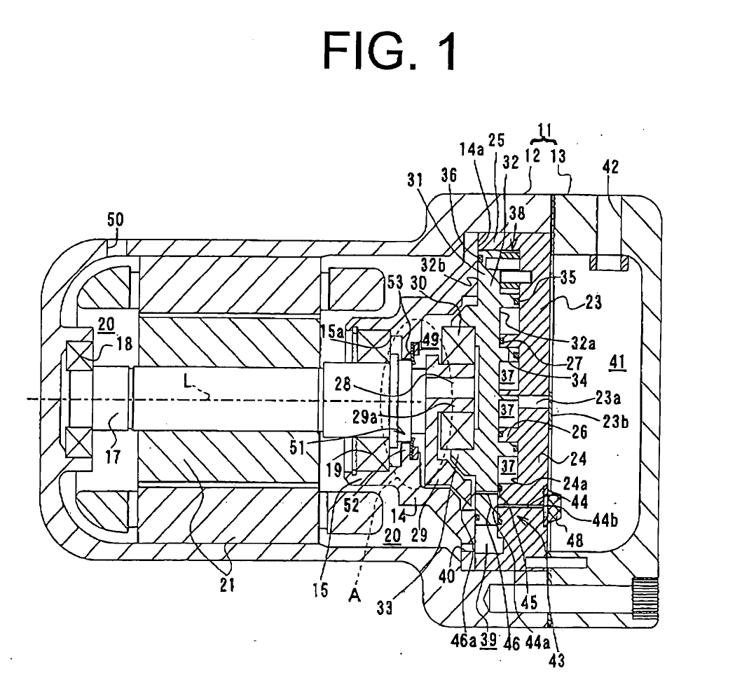

Firstly, the motor-driven scroll compressor (referred to as “compressor” hereinafter) will be described. Referring to FIG. 1, the compressor has a housing 11 that includes a first housing component 12 and a second housing component 13. In FIG. 1, the left side of the compressor (or the side adjacent to the first housing component 12) and the opposite right side thereof (or the side adjacent to the second housing component 13) correspond to the rear side and the front side of the compressor, respectively. The housing 11 also includes a shaft support member 14 that is formed integrally with the first housing component 12 on the front side thereof. The shaft support member 14 has a cylindrical portion 15 through which a rotary shaft 17 is inserted. The rotary shaft 17 is rotatably supported by the housing 11 through a radial bearing 18 disposed in the first housing component 12 and a radial bearing 19 disposed on the inner circumferential surface 15a of the cylindrical portion 15 of the shaft support member 14.

A motor chamber 20 as a low-pressure region is defined in the housing 11 on the rear side of the shaft support member 14. An electric motor 21 is provided in the motor chamber 20 and electric power is supplied to the electric motor 21 to drive the rotary shaft 17.

A fixed scroll member 23 is accommodated in the housing 11 on the front side of the shaft support member 14. The fixed scroll member 23 includes a disc-shaped fixed base plate 24, a cylindrical outer peripheral wall 25 and a fixed scroll wall 26. The outer peripheral wall 25 extends rearward from the outermost peripheral portion of the rear surface 24a of the fixed base plate 24. The fixed scroll wall 26 extends from the rear surface 24a of the fixed base plate 24 and is located inside the outer peripheral wall 25. A tip seal 27 is installed in the distal end surface of the fixed scroll wall 26. The fixed scroll member 23 is joined at the rear surface of the outer peripheral wall 25 to the front surface 14a of the shaft support member 14.

A crankshaft 28 is provided at the front end of the rotary shaft 17 in offset relation to the axis L of the rotary shaft 17. The compressor includes a balancer 29 having a boss 29a which is fixedly fitted on the crankshaft 28. A bearing 30 is mounted on the boss 29a of the balancer 29 on the outer peripheral side thereof. A movable scroll member 31 is supported by the bearing 30.

The movable scroll member 31 includes a disc-shaped movable base plate 32, a movable scroll wall 34, and a boss 33. The movable scroll wall 34 extends from the front surface 32a of the movable base plate 32, which faces the fixed base plate 24. A tip seal 35 is installed in the distal end surface of the movable scroll wall 34. The boss 33 extends from the center of the rear surface 32b or the back surface of the movable base plate 32. The boss 33 is rotatably supported by the bearing 30. The movable base plate 32 is in slide contact with the front surface 14a of the shaft support member 14 at the outer peripheral portion of the rear surface 32b thereof. A tip seal 36 is installed in the rear surface 32b in slide contact with the front surface 14a of the shaft support member 14.

The fixed and movable scroll walls 26, 34 are engaged with each other, so that compression chambers 37 are defined by the fixed and movable base plates 24, 32 and the fixed and movable scroll walls 26, 34 of the fixed scroll member 23 and the movable scroll member 31. Plural rotation preventing mechanisms 38 that are generally known are provided between the front surface 32a of the movable base plate 32 of the movable scroll member 31 and the rear surface 24a of the fixed base plate 24 of the fixed scroll member 23 (Only one shown in FIG. 1).

A suction chamber 39 is defined between the outer peripheral wall 25 of the fixed scroll member 23 and the outermost peripheral portion of the movable scroll wall 34 of the movable scroll member 31. The shaft support member 14 has a suction port 40 in the outer peripheral portion thereof, which connects the suction chamber 39 to the motor chamber 20. The first housing component 12 has an inlet 50 that connects the motor chamber 20 with an external refrigerating circuit (not shown). Therefore, low-pressure refrigerant gas is introduced from the external refrigerating circuit into the suction chamber 39 through the inlet 50, the motor chamber 20 and the suction port 40.

In the housing 11, a discharge chamber 41 is defined by the second housing component 13 and the fixed scroll member 23. The fixed scroll member 23 has a discharge port 23a at the center of the fixed base plate 24 thereof. The innermost compression chamber 37 is in communication with the discharge chamber 41 through the discharge port 23a and a discharge valve 23b. The second housing component 13 has an outlet 42 in communication with the discharge chamber 41.

As the rotary shaft 17 is driven to rotate, the movable scroll member 31 orbits around the axis of the fixed scroll member 23 (which axis exists on the axis L of the rotary shaft 17) through the crankshaft 28. At the same time, the rotation preventing mechanisms 38 prevent the movable scroll member 31 from rotating on its axis, while allowing the orbiting movement of the movable scroll member 31. As the compression chambers 37 are moved radially inwardly from the outer peripheral side of the fixed and movable scroll walls 26, 34 of the fixed and movable scroll members 23, 31 toward their center by the orbital movement of the movable scroll member 31, the compression chambers 37 progressively reduce in volume. Thereby, the low-pressure refrigerant gas introduced into the compression chambers 37 from the suction chamber 39 is compressed. The compressed high-pressure refrigerant gas is discharged from the innermost compression chamber 37 into the discharge chamber 41 through the discharge port 23a and the discharge valve 23b due to the communication of the innermost compression chamber 37 with the discharge port 23a.

The following will describe a mechanism for pressing the movable scroll member 31 against the fixed scroll member 23. The movable scroll member 31 and the shaft support member 14 in the back of the movable base plate 32 of the movable scroll member 31 cooperate to define therebetween a back pressure chamber 49. The pressure in the back pressure chamber 49 is adjusted by a back pressure regulating mechanism 43.

The back pressure regulating mechanism 43 includes a fixed passage 44 formed in the outer peripheral portion of the fixed scroll member 23, a communication groove 45 formed around the rear opening 44a of the fixed passage 44 in the fixed scroll member 23, and a movable passage 46 formed in the outer peripheral portion of the movable scroll member 31. The fixed passage 44 is in communication with the discharge chamber 41 through the front opening 44b thereof and a filter 48. The movable passage 46 is in communication with the back pressure chamber 49 through the rear opening 46a. The fixed passage 44 is brought into or out of communication with the communication groove 45 by a slight frontward or rearward movement of the movable scroll member 31.

The movable scroll member 31 is movable frontward or rearward depending on the pressure difference between the pressure in the compression chambers 37 (thrust force) and the pressure in the back pressure chamber 49 (back pressure force). When the thrust force exceeds the back pressure force in operation of the compressor, the movable scroll member 31 is pressed and moved rearward by the thrust force. A clearance is then formed between the movable scroll member 31 and the fixed scroll member 23, and the fixed passage 44 communicates with the communication groove 45 through the clearance, accordingly Therefore, high-pressure refrigerant gas is introduced from the discharge chamber 41 into the back pressure chamber 49 through the fixed passage 44, the clearance, the communication groove 45, and the movable passage 46.

On the other hand, when the back pressure force is increased by the introduction of the high-pressure refrigerant gas into the back pressure chamber 49 and exceeds the thrust force, the movable scroll member 31 is moved frontward by the back pressure force and comes into contact with the fixed scroll member 23. Then the clearance between the movable scroll member 31 and the fixed scroll member 23 disappears, and the communication between the fixed passage 44 and the communication groove 45 is blocked As a result of the above frontward movement of the movable scroll member 31, a clearance is formed between the movable scroll member 31 and the shaft support member 14. High-pressure refrigerant gas flows from the back pressure chamber 49 into the suction chamber 39 through the clearance between the movable scroll member 31 and the shaft support member 14.

As described above, the back pressure regulating mechanism 43 is operable to vary the clearance between the movable scroll member 31 and the fixed scroll member 23 and also the clearance between the movable scroll member 31 and the shaft support member 14 so that the back pressure force becomes an appropriate value in response to the thrust force, thus autonomously regulating the back pressure force. By regulating the back pressure force appropriately, sealing of the compression chambers 37 is enhanced, with the result that the compression efficiency of the compressor is improved.

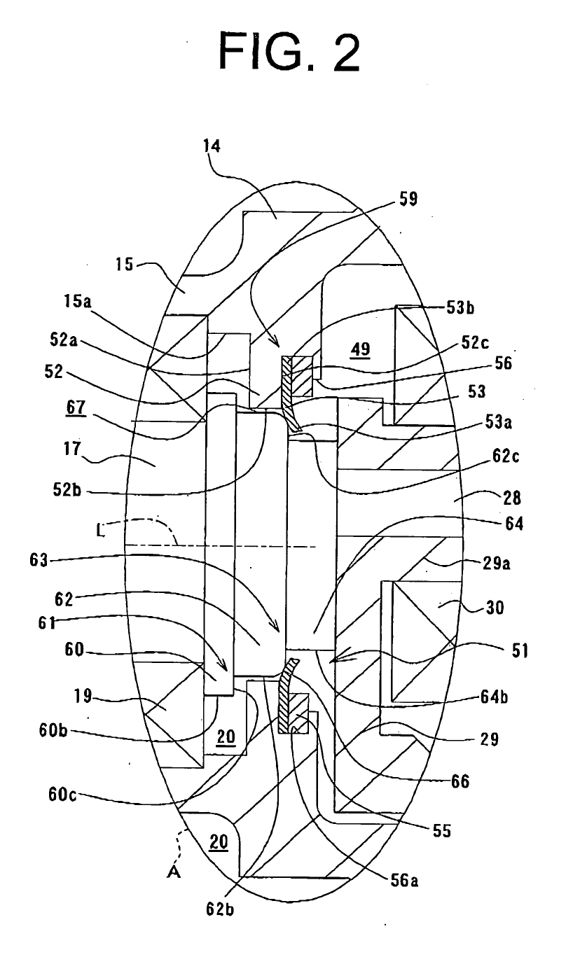

The following will describe a seal mechanism 51 of the preferred embodiment of the present invention with reference to FIG. 2. FIG. 2 shows an enlarged cross-sectional view showing part of the compressor which is enclosed by the dotted oval A in FIG. 1. The seal mechanism 51 is adapted to seal a gap 67 that is formed between the shaft support member 14 and the rotary shaft 17 in the front of the radial bearing 19 provided in the shaft support member 14. As shown in FIG. 2, the seal mechanism 51 is positioned to separate the back pressure chamber 49 as a high-pressure region and the motor chamber 20 as a low-pressure region. The rotary shaft 17 is formed adjacently to the shaft support member 14 with a large-diameter portion 60 having a diameter greater than that of the rear part of the rotary shaft 17 and serving to restrict the frontward movement of the radial bearing 19, a medium-diameter portion 62 extending frontward from the large-diameter portion 60 by way of a first stepped portion 61, and a small-diameter portion 64 extending further frontward from the medium-diameter portion 62 by way of a second stepped portion 63. The aforementioned crankshaft 28 is formed on the front end of the small-diameter portion 64.

The large-diameter portion 60 has a circumferential surface 60b facing the inner circumferential surface 15a of the cylindrical portion 15 of the shaft support member 14, and a front surface 60c facing the rear surface 52a of a fixed wall 52 which will be described later. The medium-diameter portion 62 has a circumferential surface 62b that faces the inner circumferential surface 52b of the fixed wall 52 and is coaxial with the rotary shaft 17. The medium-diameter portion 62 also has a front surface 62c as a first surface that faces back pressure chamber 49. The second stepped portion 63 has a chamfered edge 66 connecting the front surface 62c and the circumferential surface 62b. The small-diameter portion 64 has a circumferential surface 64b that is exposed to the back pressure chamber 49.

The fixed wall 52 is formed integrally with the shaft support member 14 that forms a part of the housing 11. The fixed wall 52 is formed protruding inwardly or toward the rotary shaft 17 in the space between the radial bearing 19 and the balancer 29. The fixed wall 52 has the rear surface 52a facing the motor chamber 20, the inner circumferential surface 52b facing the circumferential surface 62b of the medium-diameter portion 62, and a front surface 52c as a second surface facing the back pressure chamber 49. The fixed wall 52 has a stepped portion 59 in the front of the front surface 52c. The fixed wall 52 has at the stepped portion 59 an accommodation surface 56 whose inner diameter is larger than that of the inner circumferential surface 52b. An annular groove 56a is formed in the accommodation surface 56 of the fixed wall 52 for receiving therein a seal member 53.

The seal member 53 has an annular and plate-like shape and made of a flexible material such as resin. The seal member 53 has an inner peripheral portion 53a whose inner diameter is smaller than the outer diameter of the 2o medium-diameter portion 62 and larger than the outer diameter of the small-diameter portion 64, and an outer peripheral portion 53b whose outer diameter that is larger than the inner diameter of the accommodation surface 56. The seal member 53 is installed with the outer peripheral portion 53b thereof set in the annular groove 56a and held in place by a circlip 55 that is fitted in the annular groove 56a in the front of the outer peripheral portion 53b, as shown in FIG. 2. Thus, the seal member 53 is fixed to the shaft support member 14 in contact with the front surface 52c.

The front, surface 52c of the fixed wall 52 is located rearward of the front surface 62c of the medium-diameter portion 62, so that, when the seal member 53 is installed in place, its inner peripheral portion 53a is bent forward to be in contact with the edge 66 connecting the circumferential surface 62b and the front surface 62c, as shown in FIG. 2.

The gap 67 between the inner circumferential surface 52b of the fixed wall 52 and the circumferential surface 62b of the medium-diameter portion 62 corresponds to a gap between the housing 11 (the fixed wall 52) and the rotary shaft 17 in the present invention, and the seal member 53 blocks the fluid communication between the back pressure chamber 49 and the motor chamber 20 via the gap 67.

As described above, high-pressure refrigerant gas is introduced from the discharge chamber 41 into the back pressure chamber 49 in operation of the compressor, and the pressure in the back pressure chamber 49 becomes higher than that in the motor chamber 20, thus a pressure difference being created therebetween. Due to this pressure difference, the back pressure in the back pressure chamber 49 is applied to the seal member 53. In operation of the compressor, the seal member 53 slides relative to and in pressing contact with the edge 66, thereby to seal the gap 67.

According to the above-described first preferred embodiment, the following advantageous effects are obtained.

(1) The seal member 53 maintains its contact with the edge 66 connecting the circumferential surface 62b of the medium-diameter portion 62 of the rotary shaft 17 and the front surface 62c facing the back pressure chamber 49. Since the seal member 53 is in contact with the rotary shaft 17 substantially in a line contact manner rather than in a surface-to-surface contact manner, the contact area and hence the sliding resistance is minimized. In operation of the compressor, the pressure in the back pressure chamber 49 is increased as described earlier, so that the seal member 53 is pressed strongly against the edge 66. Thus, the seal member 53 which is pressed against the edge 66 by additional fluid pressure enhances its sealing capability. The seal mechanism 51 which dispenses with a coil spring is simple in structure. Accordingly, the seal mechanism 51 may be used advantageously at a position where the back pressure chamber 49 and the motor chamber 20 are separated in a scroll compressor that requires reduction of the sliding resistance and satisfactory sealing.

(2) The seal member 53 is fixed to the shaft support member 14 that is located round the rotary shaft 17. Thus, the distance from the axis of the rotary shaft 17 to the sliding position of the seal member 53 is shorter in comparison with the case wherein the seal member 53 is fixed to the rotary shaft 17 and slides relative to the shaft support member 14. As a result, the peripheral speed at the edge 66 of the rotary shaft 17 with which the seal member 53 maintains in contact is lower, with the result that the sliding resistance of the seal member 53 and the edge 66 is reduced.

(3) Carbon dioxide is used as the refrigerant in the compressor. Thus, the pressure in the back pressure chamber 49 becomes extremely high in operation of the compressor, and the force applied to the seal member 53 is extremely large, accordingly. However, since the seal member 53 is in contact with the edge 66, the sliding resistance is minimized, so that the sealing of the seal member 53 is further improved. Therefore, the seal mechanism 51 of the present preferred embodiment is advantageously applicable to a compressor using carbon dioxide as the refrigerant.

(4) The seal mechanism 51 is also advantageously applicable to a compressor using an electric motor such as 21 wherein the sliding resistance should be as low as possible.

The following alternative embodiments may be practiced without departing from the scope of the present invention

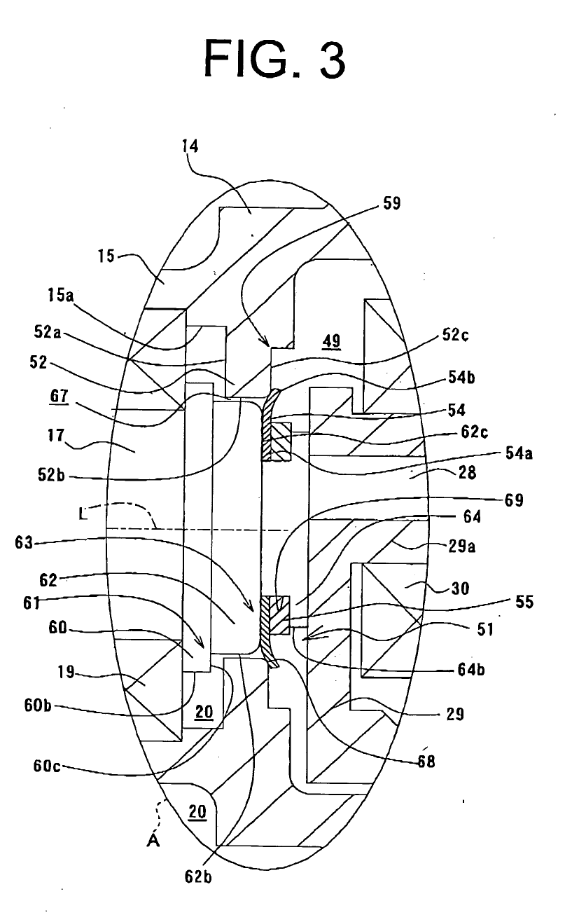

In the first preferred embodiment, the seal member 53 is fixed to the shaft support member 14 with the outer peripheral portion 53b placed therein. In the alternative embodiment shown in FIG. 3, an annular and plate-like seal member 54 is fixed to the rotary shaft 17 with the inner peripheral portion 54a thereof placed in an annular groove 69 that is formed in the circumferential surface 64b of the small-diameter portion 64 of the rotary shaft 17. The seal member 54 is in contact with the front surface 62c of the medium-diameter portion 62 as a second surface. In this case, it is so arranged that the front surface 52c of the fixed wall 52 is located forward of the front surface 62c of the medium-diameter portion 62. The outer peripheral portion 54b of the seal member 54 is bent forward to be in contact with a chamfered edge 68 connecting the front surface 52c of the fixed wall 52 as a first surface and the inner circumferential surface 52b of the fixed wall 52 as the circumferential surface that is coaxial with the rotary shaft 17. The medium-diameter and small-diameter portions 62, 64 correspond to a fixed portion of the rotary shaft of the present invention.

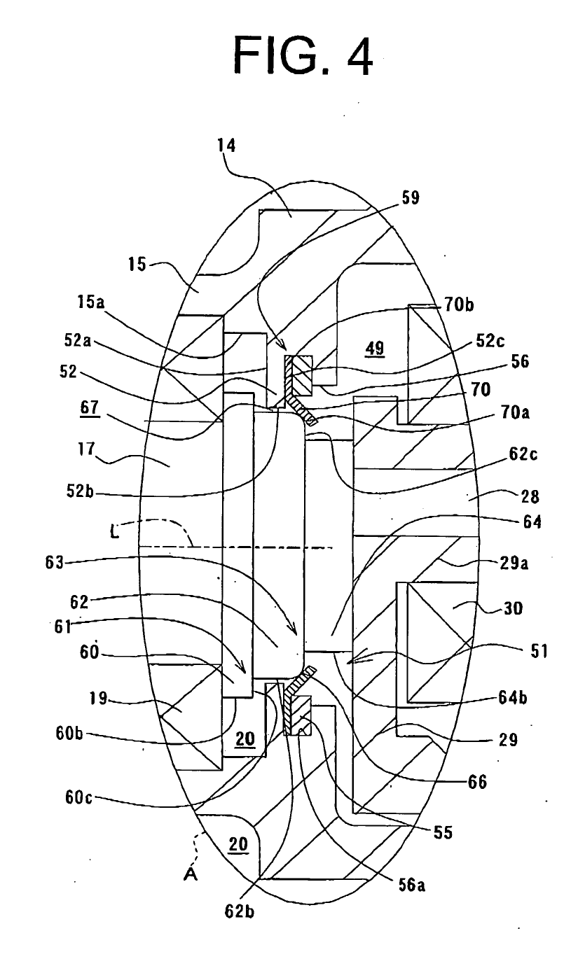

In the first preferred embodiment, the seal member 53 is made of a flexible material such as resin and it is made in contact with the edge 66 by bending. A seal member 70 of the alternative embodiment shown in FIG. 4 is made of a rigid material such as rigid metal or resin which is formed in the shape similar to that of the seal member 53 when it is bent in contact with the edge 66 as in the first preferred embodiment.

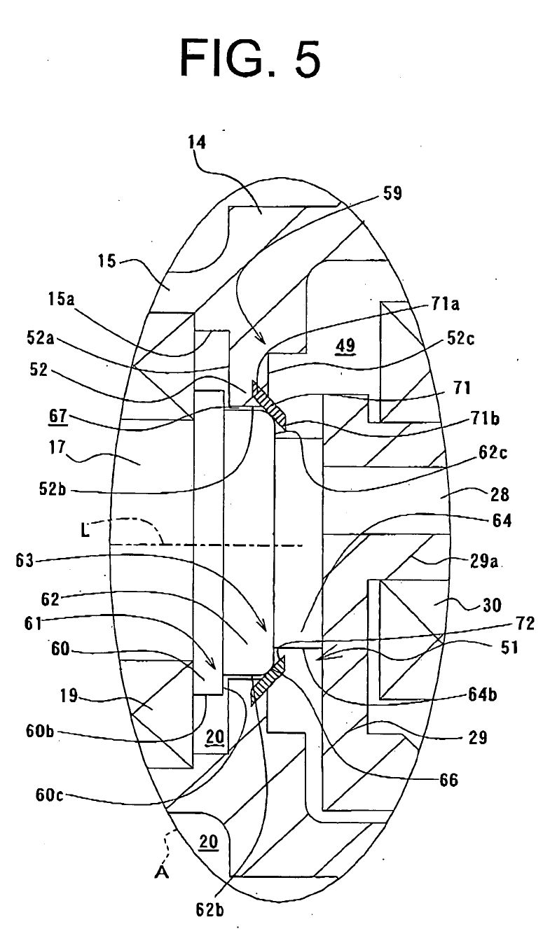

In the first preferred embodiment, the annular and plate-like seal member 53 is used. A seal member 71 of the alternative embodiment shown in FIG. 5 is of a funnel shape broadening rearwardly and has an annular and plate-like shape. The seal member 71 has a large-diameter portion 71a adjacent to the wide rear opening and a small-diameter portion 71b adjacent to the narrow front opening. The seal member 71 is set such that its large-diameter portion 71a is embedded in the fixed wall 52 and its inner circumferential surface 72 is in contact with the edge 66 at the small-diameter portion 71b, as shown in FIG. 5.

In the first preferred embodiment, the seal mechanism of the present invention is applied to a scroll type compressor. Alternatively, the present invention is applicable to compressors of other known types such as piston type and vane type.

In the first preferred embodiment, the rotary shaft 17 is driven by the electric motor 21. Alternatively, a belt type transmission may be used, in which the rotation of a vehicle engine is transmitted to the rotary shaft through a belt to drive the rotary shaft.

The present examples and embodiments are to be considered as illustrative and not restrictive, and the invention is not to be limited to the details given herein but may be modified within the scope of the appended claims.

What is claimed is:

1. A compressor for compressing gas, comprising:
a housing having a high-pressure region and a low-pressure region;
a rotary shaft rotatably supported by the housing;
a compression unit provided in the housing, the compression unit being actuated by the rotation of the rotary shaft to perform the gas compression;
a seal member having an annular and plate-like shape and provided in the housing for preventing the gas from leaking from the high-pressure region to the low-pressure region via a gap between the rotary shaft and the housing, pressure of the gas in the high-pressure region being applied to the seal member thereby generating a seal function, the seal member being fixed to one of the housing and the rotary shaft and in contact with an edge that is formed in the other of the housing and the rotary shaft and connects a first surface facing the high-pressure region and a circumferential surface coaxial with the rotary shaft in the other of the housing and the rotary shaft.

2. The compressor according to claim 1, wherein the seal member is fixed to the housing.

3. The compressor according to claim 1, wherein the rotary shaft has a stepped portion that includes the first surface, the circumferential surface and the edge, the housing having a fixed wall for fixing the seal member, the fixed wall having a second surface facing the high-pressure region and an inner circumferential surface facing the circumferential surface of the stepped portion, the first surface of the stepped portion being closer to the high-pressure region in an axial direction of the rotary shaft than the second surface of the fixed wall, the seal member having an outer peripheral portion and an inner peripheral portion, the seal member being fixed to the fixed wall at the outer peripheral portion thereof, the seal member being in contact with the edge at the inner peripheral portion thereof.

4. The compressor according to claim 1, wherein the seal member is fixed to the rotary shaft

5. The compressor according to claim 1, wherein the housing has a stepped portion including the first surface, an inner circumferential surface that is the circumferential surface coaxial with the rotary shaft and the edge, the rotary shaft having a fixed portion for fixing the seal member, the fixed portion having a second surface facing the high-pressure region and a circumferential surface facing the inner circumferential surface of the stepped portion, the first surface of the stepped portion being closer to the high-pressure region in an axial direction of the rotary shaft than the second surface of the fixed portion, the seal member having an outer peripheral portion and an inner peripheral portion, the seal member being fixed to the fixed portion at the inner peripheral portion thereof, the seal member being in contact with the edge at the outer peripheral portion thereof.

6. The compressor according to claim 1, wherein the compression unit includes a fixed scroll member fixed to the housing and having a base plate and a scroll wall and a movable scroll member having a base plate and a scroll wall and engaged with the fixed scroll member to form a compression chamber therebetween, an orbital mechanism being provided between the rotary shaft and the movable scroll member for converting the rotation of the rotary shaft into orbital movement of the movable scroll member, the compression chamber being radially inwardly moved by the orbital movement of the movable scroll member while reducing in volume thereby performing the gas compression, the housing having a fixed wall, the high-pressure region being a back pressure chamber defined between the movable scroll member and the fixed wall on a back side of the base plate of the movable scroll member, the gap being formed between the rotary shaft and the fixed wall.

7. The compressor according to claim 1, wherein the gas is refrigerant in a refrigerating circuit and carbon dioxide.

8. The compressor according to claim 1, wherein the rotary shaft is driven by an electric motor.

9. The compressor according to claim 1, wherein the seal member is made of a flexible material.

10. The compressor according to claim 1, wherein the seal member is made of a rigid material.

11. The compressor according to claim 1, wherein the seal member has a funnel shape.

12. The compressor according to claim 1, wherein the edge is chamfered.
